(19) United States
(12) Patent Application Publication
(10) Pub. No.: US 2023/0028678 A1
(43) Pub. Date: Jan. 26, 2023

(54) DETERMINING SHARED NODES BETWEEN SNAPSHOTS USING PROBABILISTIC DATA STRUCTURES

(71) Applicant: VMware, Inc., Palo Alto, CA (US)

(72) Inventors: Nitin Rastogi, Palo Alto, CA (US); Wenguang Wang, Santa Clara, CA (US); Pranay Singh, Palo Alto, CA (US); Subhradyuti Sarkar, Palo Alto, CA (US); Enning Xiang, Palo Alto, CA (US)

(73) Assignee: VMware, Inc., Palo Alto, CA (US)

(21) Appl. No.: 17/383,087

(22) Filed: Jul. 22, 2021

(51) Int. Cl. G06F 16/11; G06F 16/16; G06F 16/188; G06F 16/13; G06F 16/901

(52) U.S. Cl. CPC G06F 16/128; G06F 16/162; G06F 16/188; G06F 16/137; G06F 16/9027

(57) ABSTRACT

The present disclosure is related to methods, systems, and machine-readable media for determining shared nodes between snapshots using probabilistic data structures. A unique identifier can be assigned to each node of a first tree data structure corresponding to a first snapshot of a virtual computing instance (VCI). A first probabilistic data structure representing the first tree data structure can be created that includes hashes of the identifiers assigned to the nodes of the first tree data structure. A unique identifier can be assigned to each node of a second tree data structure corresponding to a second snapshot of the VCI. A second probabilistic data structure representing the second tree data structure can be created that includes hashes of the identifiers assigned to the nodes of the second tree data structure. A particular node of the second tree data structure can be determined to be shared by the first tree data structure responsive to a determination that the first probabilistic data structure includes a hash of an identifier assigned to the particular node.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Snapshots may be utilized in a software defined data center to provide backups and/or disaster recovery. For instance, a snapshot can be used to revert to a previous version or state of a VCI. Snapshots may utilize a copy-on-write policy that involves sharing storage, which, while being space efficient, makes deletion problematic. Some previous approaches keep reference counts of nodes and later check these reference counts to determine whether a node is shared or capable of being deleted. These approaches introduce an amount of write amplification sufficient to cause noticeable slowdowns. Other approaches may query snapshots directly to determine if a node is reachable from its root. These approaches suffer from many slow and expensive disk reads.

### BRIEF DESCRIPTION OF THE DRAWINGS

FIG. 1 is a diagram of a host and a system for determining shared nodes between snapshots using probabilistic data structures according to one or more embodiments of the present disclosure.

FIG. 2A illustrates an example file system B-tree according to one or more embodiments of the present disclosure at a first time instance.

FIG. 2B illustrates the example file system B-tree at a second time instance.

FIG. 3 illustrates two example file system B-trees and representative probabilistic data structures, each belonging to a snapshot of a given VDFS sub-volume according to one or more embodiments of the present disclosure.

FIG. 4 illustrates three example file system B-trees and representative probabilistic data structures, each belonging to a snapshot of the given VDFS sub-volume according to one or more embodiments of the present disclosure.

FIG. 5 is a diagram of a system for determining shared nodes between snapshots using probabilistic data structures according to one or more embodiments of the present disclosure.

FIG. 6 is a diagram of a machine for determining shared nodes between snapshots using probabilistic data structures according to one or more embodiments of the present disclosure.

FIG. 7 is a flow chart illustrating one or more methods for determining shared nodes between snapshots using probabilistic data structures according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

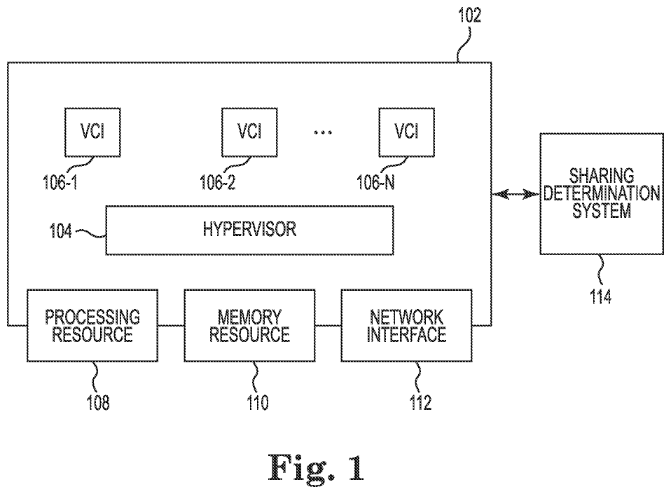

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (referred to herein simply as “snapshot”) is a copy of a disk file of a VCI at a given point in time. A snapshot can preserve the state of a VCI so that it can be reverted to at a later point in time. The snapshot can include memory as well. In some embodiments, a snapshot includes secondary storage, while primary storage is optionally included with the snapshot. A snapshot can store changes from a parent snapshot (e.g., without storing an entire copy of the parent snapshot). Snapshots provide filesystems the ability to take an instantaneous copy of the filesystem. An instantaneous copy allows the restoration of older versions of a file or directory from an accidental deletion, for instance. Snapshots also provide the foundation for other disaster recovery features, such as backup applications and/or snapshot-based replication.

A Virtual Distributed File System (VDFS) is a hyper converged distributed file system. VDFS provides the ability to take a snapshot of a file share by using a tree data structure (e.g., a CoW B-tree), which is sometimes referred to herein simply as a “tree.” A snapshot can be considered a copy of a file-share (sub-volume) as it preserves data and metadata for the entire file-share, so one can create a point in time read-only image of the file system. Many sub-volumes can be created in a single VDFS volume. Each snapshot of a sub-volume shares data blocks and metadata with other snapshots of the same sub-volume. The sharing of data and metadata makes snapshots in VDFS space efficient. Units of data that are shared between two or more snapshots can be said to be “common” to those two or more snapshots.

A tree corresponding to a snapshot includes one or more nodes. A node, as referred to herein, is a unit of data storage. In some cases, a node may be a page of data. It is noted, however, that nodes in accordance with the present disclosure may be of different sizes (e.g., 4 kilobytes, 8 kilobytes, etc.). In some embodiments, a node spans across multiple pages in size. As previously discussed, snapshots may utilize a copy-on-write policy that involves sharing storage, which, while being space efficient, makes deletion of nodes problematic. Some previous approaches keep reference counts of nodes and later check these reference counts to determine whether a node is shared or whether it is capable of being deleted. These approaches introduce an amount of write amplification sufficient to cause noticeable slowdowns. Other approaches may query snapshots directly to determine if a node is reachable from its root. These approaches suffer from many slow and expensive disk reads.

Embodiments of the present disclosure can determine whether a node of a first snapshot is shared with a second snapshot or if it is exclusively owned by the first snapshot. Embodiments herein can make such a determination with reduced write amplification and disk reads compared to previous approaches. As a result, embodiments herein can improve the functioning of a computing device in a virtualized environment. A determination of whether a node is shared may be made in order to perform a number of functions. In an example, a proposed deletion of a node should be prevented if it is shared between snapshots but can be allowed if the node is not shared. In another example, a node can be written if it is exclusively owned and not shared but may require copy-on-write if it is shared.

In some embodiments, each node of a tree is assigned a unique identifier (e.g., a monotonically increasing PageId), and a probabilistic data structure is created representing with each snapshot. The probabilistic data structure representing a given snapshot includes all the unique identifiers (e.g., hashes of the unique identifiers) for the nodes reachable from the root node of the snapshot. Whether a node is shared or not shared can become a set membership problem. Stated differently, if the hash of a unique identifier is present in two probabilistic data structures corresponding to two snapshots, embodiments herein can determine that the node is shared by the two snapshots. Alternatively, if the hash of the unique identifier is present in only one of two probabilistic data structures corresponding to two snapshots, embodiments herein can determine that the node is not shared by the two snapshots.

In some embodiments, a Cuckoo filter is used as the probabilistic data structure. As known to those of skill in the art, a Cuckoo filter can support additions and/or removals of entries on the fly. Accordingly, if a node is deleted from, or added to, a snapshot, its identifier can be deleted from, or added to, the Cuckoo filter representing the snapshot. Accordingly, embodiments herein function with both readable and writeable snapshots, and are applicable to any tree data structures with unique node identifiers (e.g., B−trees, B+trees, binary trees, AVL trees, tries, etc.). Further, embodiments herein operate independent of node data layout and/or node size.

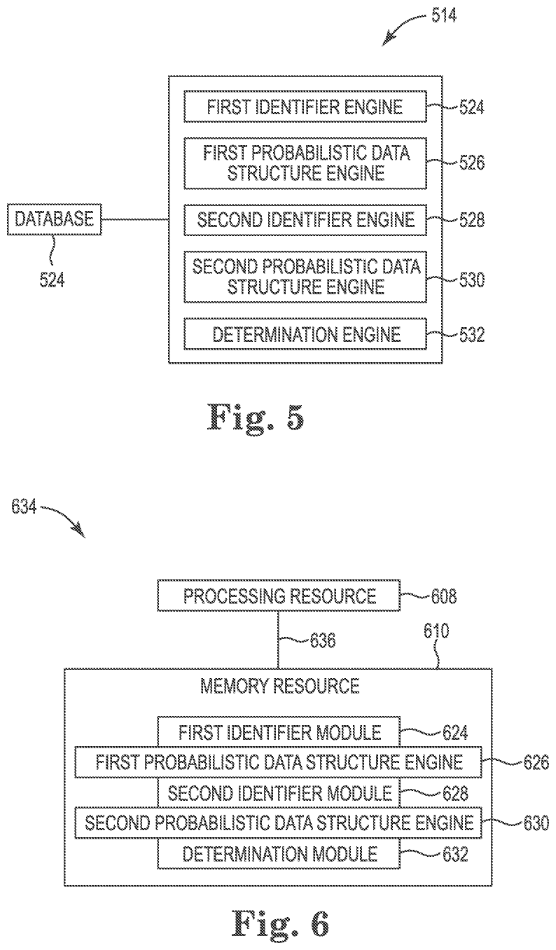

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system for determining shared nodes between snapshots using probabilistic data structures according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a sharing determination system 114. An example of the determination system is illustrated and described in more detail below. In some embodiments, the sharing determination system 114 can be a server, such as a web server.

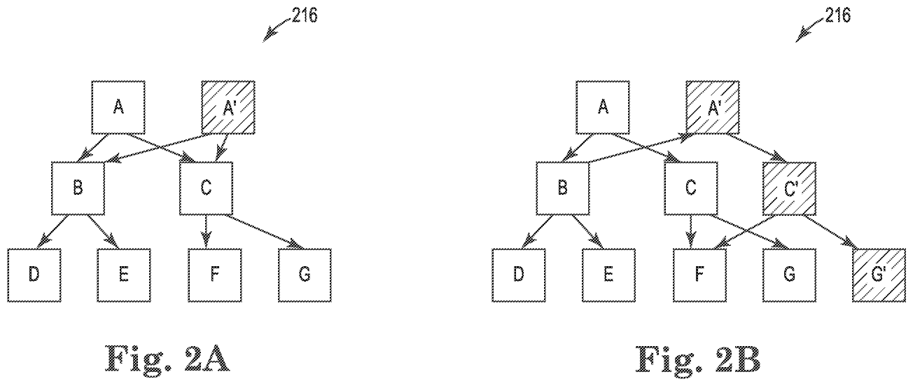

FIG. 2A illustrates an example file system B-tree 216 according to one or more embodiments of the present disclosure at a first time instance. FIG. 2B illustrates the example file system B-tree 216 at a second time instance. FIGS. 2A and 2B may be cumulatively referred to herein as “FIG. 2.” As shown in FIG. 2, the B-tree 216 includes an old root node A and new root node A′. The latest version of the file system (e.g., new writes) would point to root node A′, whereas the older root node A would be pointed to by snapshot. A live sub-volume represents the share of the file system where files are created and deleted, whereas snapshots are accessed via a special directory “/.vdfs/snapshot”. As new writes happen to the live sub-volume, the two B−trees start to differ. Thus, as shown in FIG. 2B, nodes C′ and G′ have been added as child nodes of root node A′.

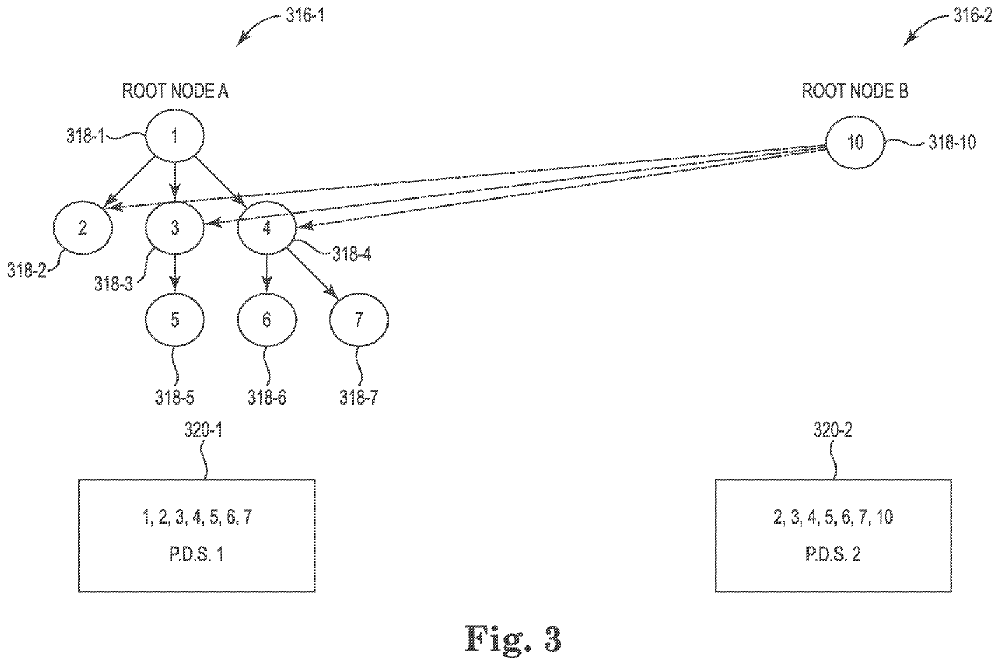

FIG. 3 illustrates two example file system B−trees and representative probabilistic data structures, each belonging to a snapshot of a given VDFS sub-volume according to one or more embodiments of the present disclosure. The file system B−trees illustrated in FIG. 3 include a first tree 316-1 and a second tree 316-2. The first tree 316-1 may be alternatively referred to as “snapshot A” and the second tree 316-2 may be alternatively referred to as “snapshot B.” In FIG. 3, circles represent the nodes of the trees 316 and the label on each node is an identifier associated with that node. For instance, the first tree 316-1 includes a root node 318-1, a node with identifier “2” 318-2, a node with identifier “3” 318-3, a node with identifier “4” 318-4, a node with identifier “5” 318-5, a node with identifier “6” 318-6, a node with identifier “7” 318-7. The second tree 316-2 includes a root node 318-10, which is a copy of the root node 318-1 made when snapshot B was created. As indicated by the dotted lines shown in FIG. 3, the second tree 316-2 shares nodes 318-2, 318-3, and 318-4 with the first tree 316-1.

Each of the trees 316-1 and 316-2 has a probabilistic data structure representation. For instance, a first probabilistic data structure 320-1 represents the first tree 316-1 and a second probabilistic data structure 320-2 represents the second tree 316-2. The second probabilistic data structure 320-2 can be copied from the first probabilistic data structure 320-1 when snapshot B is created. As previously discussed, a probabilistic data structure includes hashes of the identifiers assigned to the nodes of the tree it represents. In an example, the node 318-2 is added to the probabilistic data structure (e.g., Cuckoo filter) 320-1 using a hash function. Similarly, when they are created, the other nodes of the tree 316-1 (e.g., the identifiers of the nodes) are added to the first probabilistic data structure 320-1, each using the hash function. As shown in the example illustrated in FIG. 3, the first probabilistic data structure 320-1 includes the identifiers 1, 2, 3, 4, 5, 6, and 7. It is noted that the identifiers themselves, rather than hashes of the identifiers, are illustrated in the example probabilistic data structures described herein for purposes of clarity. As shown in the example illustrated in FIG. 3, the second probabilistic data structure 320-2, which represents the second tree 316-2, includes the identifiers 2, 3, 4, 5, 6, 7, and 10.

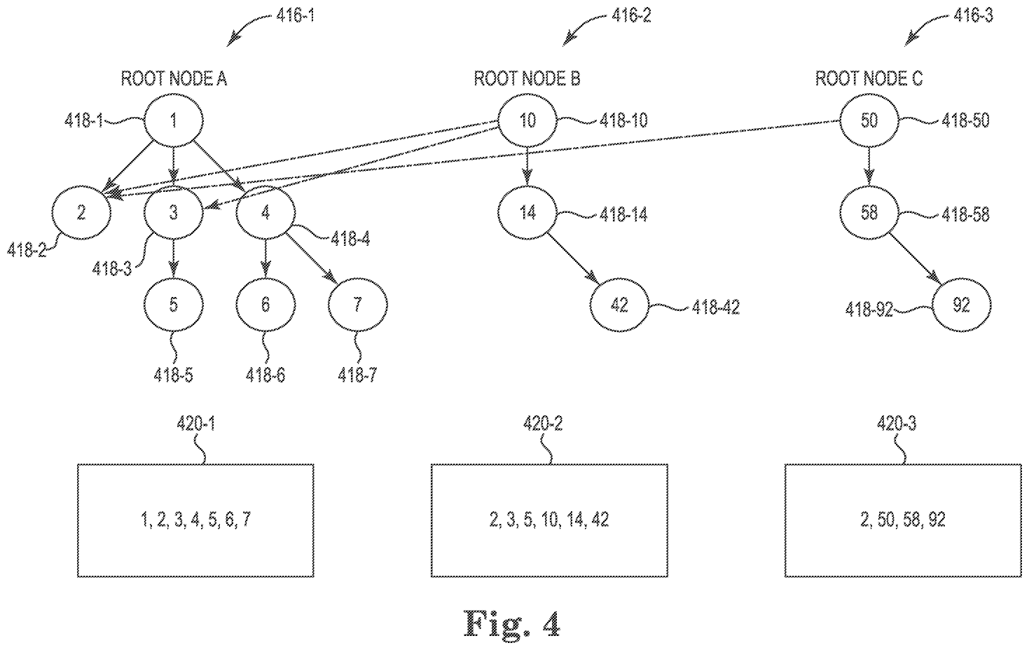

FIG. 4 illustrates three example file system B−trees and representative probabilistic data structures, each belonging to a snapshot of the given VDFS sub-volume according to one or more embodiments of the present disclosure. The file system B−trees and representative probabilistic data structures illustrated in FIG. 4 can be at a second (e.g., later) time instance than the file system B−trees and representative probabilistic data structures illustrated in FIG. 3, for instance.

The file system B−trees illustrated in FIG. 4 include a first tree 416-1, a second tree 416-2, and a third tree 416-3. The first tree 416-1 may be alternatively referred to as “snapshot A,” the second tree 316-2 may be alternatively referred to as “snapshot B,” and the third tree 416-3 may be alternatively referred to as “snapshot C.” In FIG. 4, as in FIG. 3, previously discussed, circles represent the nodes of the trees 416 and the label on each node is an identifier associated with that node. For instance, the first tree 416-1 includes a root node 418-1, a node with identifier “2” 418-2, a node with identifier “3” 418-3, a node with identifier “4” 418-4, a node with identifier “5” 418-5, a node with identifier “6” 418-6, a node with identifier “7” 418-7. The second tree 416-2 includes a root node 418-10, which is a copy of the root node 418-1 made when snapshot B was created. As indicated by the dotted lines shown in FIG. 4, the second tree 416-2 shares nodes 418-2 and 418-3 with the first tree 416-1. The third tree 416-3 includes a root node 418-50, which is a copy of the root node 418-10 made when snapshot C was created. The third tree 416-3 additionally includes a node with identifier “58” 418-58, and a node with identifier “92” 418-92. As indicated by the dotted lines shown in FIG. 4, the third tree 416-3 shares node 418-2 with the first tree 416-1.

Each of the trees 416-1, 416-2, and 416-3 has a probabilistic data structure representation. For instance, a first probabilistic data structure 420-1 represents the first tree 416-1, a second probabilistic data structure 420-2 represents the second tree 416-2, and a third probabilistic data structure 420-3 represents the third tree 416-3. The second probabilistic data structure 420-2 can be copied from the first probabilistic data structure 420-1 when snapshot B is created. The third probabilistic data structure 420-3 can be copied from the second probabilistic data structure 420-2 when snapshot C is created. As shown in the example illustrated in FIG. 4, the first probabilistic data structure 420-1 includes the identifiers 1, 2, 3, 4, 5, 6, and 7, the second probabilistic data structure 420-2, which represents the second tree 316-2, includes the identifiers 2, 3, 5, 10, 14, and 42, and the third probabilistic data structure 420-3, which represents the third tree 416-3, includes the identifiers 2, 50, 58, and 92.

As previously discussed, whether a node is shared or not shared can become a set membership problem, wherein if the hash of a unique identifier is present in two probabilistic data structures corresponding to two snapshots, the node is shared by the two snapshots. Alternatively, if the hash of the unique identifier is present in only one of two probabilistic data structures corresponding to two snapshots, the node is not shared by the two snapshots.

In some instances, a user may desire to determine which nodes are shared by two snapshots. In some instances, a user may desire to delete a snapshot. To determine which nodes are shared by two snapshots, the probabilistic data structures representing the two snapshots can be compared. In some embodiments, if a node is shared, the node is skipped. In some embodiments, if a node is not shared, additional processing is performed on that node. Additional processing can include writing to the node or hollowing out the node (e.g., for deleting the node).

If, for instance, a user indicates a desire to delete a snapshot, embodiments of the present disclosure can compare the probabilistic data structure of that snapshot with the probabilistic data structure of the preceding snapshot and with the probabilistic data structure of the subsequent snapshot. For example, if a user requests to delete snapshot B, the second probabilistic data structure 420-2 can be compared with the first probabilistic data structure 420-1 and the third probabilistic data structure 420-3. As shown, the identifier “2” is found in the second probabilistic data structure 420-2, the first probabilistic data structure 420-1, and the third probabilistic data structure 420-3. Additionally, the identifiers “3” and “5” are found in the second probabilistic data structure 420-2 and the first probabilistic data structure 420-1. The corresponding nodes, 418-2, 418-3, and 418-5 are shared nodes and can be skipped (e.g., not deleted). The identifier(s) of the second probabilistic data structure that are not present in either of the first probabilistic data structure 420-1 or the third probabilistic data structure 420-3 can be deleted. As shown, the non-shared identifiers of the second probabilistic data structure 420-2 include “10,” “14,” and “42.” The corresponding nodes, 418-10, 418-14, and 418-42 are non-shared nodes and can be deleted. As may be known to those of skill in the art, deleting a snapshot can be considered a two-step process. The first step can be termed as “hollowing out,” wherein any extents that are owned by the snapshot are deleted. The second step can involve deleting non-shared nodes of the B-tree.

FIG. 5 is a diagram of a system 514 for determining shared nodes between snapshots using probabilistic data structures according to one or more embodiments of the present disclosure. The system 514 can include a database 522 and/or a number of engines, for example first identifier engine 524, first probabilistic data structure engine 526, second identifier engine 528, second probabilistic data structure engine 530, and/or determination engine 532, and can be in communication with the database 522 via a communication link. The system 514 can include additional or fewer engines than illustrated to perform the various functions described herein. The system can represent program instructions and/or hardware of a machine (e.g., machine 634 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the first identifier engine 532 can include a combination of hardware and program instructions that is configured to assign a unique identifier to each node of a first tree data structure corresponding to a first snapshot of a VCI. In some embodiments, the first probabilistic data structure engine 526 can include a combination of hardware and program instructions that is configured to create a first probabilistic data structure representing the first tree data structure, wherein the first probabilistic data structure includes hashes of the identifiers assigned to the nodes of the first tree data structure. In some embodiments, the second identifier engine 528 can include a combination of hardware and program instructions that is configured to assign a unique identifier to each node of a second tree data structure corresponding to a second snapshot of the VCI. In some embodiments, the second probabilistic data structure engine 530 can include a combination of hardware and program instructions that is configured to create a second probabilistic data structure representing the second tree data structure, wherein the second probabilistic data structure includes hashes of the identifiers assigned to the nodes of the second tree data structure.

In some embodiments, the determination engine 532 can include a combination of hardware and program instructions that is configured to determine that a particular node of the second tree data structure is shared by the first tree data structure responsive to a determination that the first probabilistic data structure includes a hash of an identifier assigned to the particular node. In some embodiments, the determination engine 532 can include a combination of hardware and program instructions that is configured to determine that another particular node of the second tree data structure is not shared by the first tree data structure responsive to a determination that the first probabilistic data structure does not include a hash of an identifier assigned to the other particular node.

FIG. 6 is a diagram of a machine for determining shared nodes between snapshots using probabilistic data structures according to one or more embodiments of the present disclosure. The machine 634 can utilize software, hardware, firmware, and/or logic to perform a number of functions. The machine 634 can be a combination of hardware and program instructions configured to perform a number of functions (e.g., actions). The hardware, for example, can include a number of processing resources 608 and a number of memory resources 610, such as a machine-readable medium (MRM) or other memory resources 610. The memory resources 610 can be internal and/or external to the machine 634 (e.g., the machine 634 can include internal memory resources and have access to external memory resources). In some embodiments, the machine 634 can be a VCI. The program instructions (e.g., machine-readable instructions (MRI)) can include instructions stored on the MRM to implement a particular function (e.g., an action such as creating a first probabilistic data structure). The set of MRI can be executable by one or more of the processing resources 608. The memory resources 610 can be coupled to the machine 634 in a wired and/or wireless manner. For example, the memory resources 610 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 610 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 608 can be coupled to the memory resources 610 via a communication path 636. The communication path 636 can be local or remote to the machine 634. Examples of a local communication path 636 can include an electronic bus internal to a machine, where the memory resources 610 are in communication with the processing resources 608 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 636 can be such that the memory resources 610 are remote from the processing resources 608, such as in a network connection between the memory resources 610 and the processing resources 608. That is, the communication path 636 can be a network connection. Examples of such a network connection can include a local area network (LAN), wide area network (WAN), personal area network (PAN), and the Internet, among others.

As shown in FIG. 6, the MM stored in the memory resources 610 can be segmented into a number of modules 624, 626, 628, 630, 632 that when executed by the processing resources 608 can perform a number of functions. As used herein a module includes a set of instructions included to perform a particular task or action. The number of modules 624, 626, 628, 630, 632 can be sub-modules of other modules. For example, the second identifier module 628 can be a sub-module of the first identifier module 624 and/or can be contained within a single module. Furthermore, the number of modules 624, 626, 628, 630, 632 can comprise individual modules separate and distinct from one another. Examples are not limited to the specific modules 624, 626, 628, 630, 632 illustrated in FIG. 6.

Each of the number of modules 624, 626, 628, 630, 632 can include program instructions and/or a combination of hardware and program instructions that, when executed by a processing resource 608, can function as a corresponding engine as described with respect to FIG. 5. For example, the first identifier module 624 can include program instructions and/or a combination of hardware and program instructions that, when executed by a processing resource 608, can function as the first identifier engine 524, though embodiments of the present disclosure are not so limited.

The machine 634 can include a first identifier module 624, which can include instructions to assign a unique identifier to each node of a first tree data structure corresponding to a first snapshot of a VCI. The machine 634 can include a first probabilistic data structure module 626, which can include instructions to create a first probabilistic data structure representing the first tree data structure, wherein the first probabilistic data structure includes hashes of the identifiers assigned to the nodes of the first tree data structure. The machine 634 can include a second identifier module 628, which can include instructions to assign a unique identifier to each node of a second tree data structure corresponding to a second snapshot of the VCI. The machine 634 can include a second probabilistic data structure module 630, which can include instructions to create a second probabilistic data structure representing the second tree data structure, wherein the second probabilistic data structure includes hashes of the identifiers assigned to the nodes of the second tree data structure. The machine 634 can include a determination module 632, which can include instructions to determine that a particular node of the second tree data structure is shared by the first tree data structure responsive to a determination that the first probabilistic data structure includes a hash of an identifier assigned to the particular node.

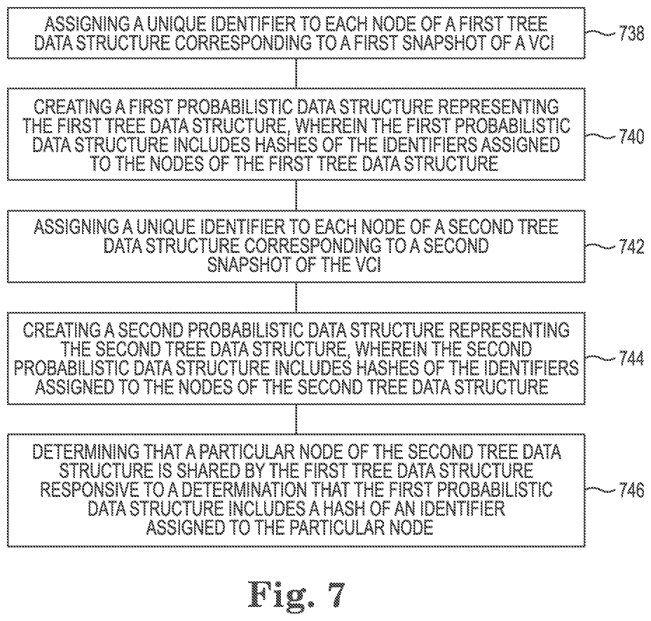

FIG. 7 is a flow chart illustrating one or more methods for determining shared nodes between snapshots using probabilistic data structures according to one or more embodiments of the present disclosure. The method can include, at 738, assigning a unique identifier to each node of a first tree data structure corresponding to a first snapshot of a VCI.

The method can include, at 740, creating a first probabilistic data structure representing the first tree data structure, wherein the first probabilistic data structure includes hashes of the identifiers assigned to the nodes of the first tree data structure. The method can include, at 742, assigning a unique identifier to each node of a second tree data structure corresponding to a second snapshot of the VCI. The method can include, at 744, creating a second probabilistic data structure representing the second tree data structure, wherein the second probabilistic data structure includes hashes of the identifiers assigned to the nodes of the second tree data structure. The method can include, at 746, determining that a particular node of the second tree data structure is shared by the first tree data structure responsive to a determination that the first probabilistic data structure includes a hash of an identifier assigned to the particular node. Although not specifically shown in FIG. 7, the method can include determining that another particular node of the second tree data structure is not shared by the first tree data structure responsive to a determination that the first probabilistic data structure does not include a hash of an identifier assigned to the other particular node, and hollowing out the other particular node responsive to the determination that the other particular node is not shared.

Although not specifically shown in FIG. 7, the method can include assigning a unique identifier to each node of a third tree data structure corresponding to a third snapshot of the VCI, creating a third probabilistic data structure representing the third tree data structure, wherein the third probabilistic data structure includes hashes of the identifiers assigned to the nodes of the third tree data structure, and receiving a request to delete the second snapshot.

In some embodiments, after receiving the request to delete the second snapshot the method can include determining that a particular node of the second tree data structure is shared by either the first tree data structure or the third tree data structure responsive to a determination that the first probabilistic data structure or the third probabilistic data structure includes a hash of an identifier assigned to the particular node and not deleting the particular node responsive to the determination that the particular node is shared.

In some embodiments, after receiving the request to delete the second snapshot the method can include determining that a particular node of the second tree data structure is not shared by either the first tree data structure or the third tree data structure responsive to a determination that neither the first probabilistic data structure nor the third probabilistic data structure includes a hash of an identifier assigned to the particular node and deleting the particular node responsive to the determination that the particular node is not shared.

As previously discussed, new and/or deleted nodes can be accounted for in the representative probabilistic data structure. For instance, in some embodiments, the method can include assigning a new unique identifier to a new node of the first tree data structure and adding a hash of the new identifier to the first probabilistic data structure. In some embodiments, the method can include receiving an indication of a node deleted from the first tree data structure and removing a hash of an identifier assigned to the deleted node from the first probabilistic data structure.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
assigning a unique identifier to each node of a first tree data structure corresponding to a first snapshot of a virtual computing instance (VCI);
creating a first probabilistic data structure representing the first tree data structure, wherein the first probabilistic data structure includes hashes of the identifiers assigned to the nodes of the first tree data structure;
assigning a unique identifier to each node of a second tree data structure corresponding to a second snapshot of the VCI;
creating a second probabilistic data structure representing the second tree data structure, wherein the second probabilistic data structure includes hashes of the identifiers assigned to the nodes of the second tree data structure; and
determining that a particular node of the second tree data structure is shared by the first tree data structure responsive to a determination that the first probabilistic data structure and the second probabilistic data structure each include a hash of an identifier assigned to the particular node.

2. The method of claim 1, wherein the method includes determining that another particular node of the second tree data structure is not shared by the first tree data structure responsive to a determination that the first probabilistic data structure does not include a hash of an identifier assigned to the other particular node.

3. The method of claim 2, wherein the method includes deleting extents of the other particular node responsive to the determination that the other particular node is not shared.

4. The method of claim 1, wherein the method includes:
assigning a unique identifier to each node of a third tree data structure corresponding to a third snapshot of the VCI;
creating a third probabilistic data structure representing the third tree data structure, wherein the third probabilistic data structure includes hashes of the identifiers assigned to the nodes of the third tree data structure;
receiving a request to delete the second snapshot;
determining that a particular node of the second tree data structure is shared by either the first tree data structure or the third tree data structure responsive to a determination that the first probabilistic data structure or the third probabilistic data structure includes a hash of an identifier assigned to the particular node; and
not deleting the particular node responsive to the determination that the particular node is shared.

5. The method of claim 1, wherein the method includes:
assigning a unique identifier to each node of a third tree data structure corresponding to a third snapshot of the VCI, wherein the third snapshot is writeable;
creating a third probabilistic data structure representing the third tree data structure, wherein the third probabilistic data structure includes hashes of the identifiers assigned to the nodes of the third tree data structure;
receiving a request to delete the second snapshot;
determining that a particular node of the second tree data structure is not shared by either the first tree data structure or the third tree data structure responsive to a determination that neither the first probabilistic data structure nor the third probabilistic data structure includes a hash of an identifier assigned to the particular node; and
deleting the particular node responsive to the determination that the particular node is not shared.

6. The method of claim 1, wherein the method includes:
assigning a new unique identifier to a new node of the first tree data structure, wherein the first tree data structure is one of: a B−tree, a B+tree, a binary tree, an AVL tree, and a trie; and
adding a hash of the new identifier to the first probabilistic data structure.

7. The method of claim 1, wherein the method includes:
receiving an indication of a node deleted from the first tree data structure, wherein nodes of the first tree data structure vary in size; and
removing a hash of an identifier assigned to the deleted node from the first probabilistic data structure.

8. A non-transitory machine-readable medium having instructions stored thereon which, when executed by a processor, cause the processor to:
assign a unique identifier to each node of a first tree data structure corresponding to a first snapshot of a virtual computing instance (VCI);
create a first probabilistic data structure representing the first tree data structure, wherein the first probabilistic data structure includes hashes of the identifiers assigned to the nodes of the first tree data structure;
assign a unique identifier to each node of a second tree data structure corresponding to a second snapshot of the VCI;
create a second probabilistic data structure representing the second tree data structure, wherein the second probabilistic data structure includes hashes of the identifiers assigned to the nodes of the second tree data structure; and
determine that a particular node of the second tree data structure is shared by the first tree data structure responsive to a determination that the first probabilistic data structure and the second probabilistic data structure each include a hash of an identifier assigned to the particular node.

9. The medium of claim 8, including instructions to determine that another particular node of the second tree data structure is not shared by the first tree data structure responsive to a determination that the first probabilistic data structure does not include a hash of an identifier assigned to the other particular node.

10. The medium of claim 9, including instructions to delete extents of the other particular node responsive to the determination that the other particular node is not shared.

11. The medium of claim 8, including instructions to:
assign a unique identifier to each node of a third tree data structure corresponding to a third snapshot of the VCI;
create a third probabilistic data structure representing the third tree data structure, wherein the third probabilistic data structure includes hashes of the identifiers assigned to the nodes of the third tree data structure;
receive a request to delete the second snapshot;
determine that a particular node of the second tree data structure is shared by either the first tree data structure or the third tree data structure responsive to a determination that the first probabilistic data structure or the third probabilistic data structure includes a hash of an identifier assigned to the particular node; and
not delete the particular node responsive to the determination that the particular node is shared.

12. The medium of claim 8, including instructions to:
assign a unique identifier to each node of a third tree data structure corresponding to a third snapshot of the VCI, wherein the third snapshot is writeable;
create a third probabilistic data structure representing the third tree data structure, wherein the third probabilistic data structure includes hashes of the identifiers assigned to the nodes of the third tree data structure;
receive a request to delete the second snapshot;
determine that a particular node of the second tree data structure is not shared by either the first tree data structure or the third tree data structure responsive to a determination that neither the first probabilistic data structure nor the third probabilistic data structure includes a hash of an identifier assigned to the particular node; and
delete the particular node responsive to the determination that the particular node is not shared.

13. The medium of claim 8, including instructions to:
assign a new unique identifier to a new node of the first tree data structure, wherein the first tree data structure is one of: a B−tree, a B+tree, a binary tree, an AVL tree, and a trie; and
add a hash of the new identifier to the first probabilistic data structure.

14. The medium of claim 8, including instructions to:
receive an indication of a node deleted from the first tree data structure, wherein nodes of the first tree data structure vary in size; and
remove a hash of an identifier assigned to the deleted node from the first probabilistic data structure.

15. A system, comprising:
a first identifier engine configured to assign a unique identifier to each node of a first tree data structure corresponding to a first snapshot of a virtual computing instance (VCI);
a first probabilistic data structure engine configured to create a first probabilistic data structure representing the first tree data structure, wherein the first probabilistic data structure includes hashes of the identifiers assigned to the nodes of the first tree data structure;
a second identifier engine configured to assign a unique identifier to each node of a second tree data structure corresponding to a second snapshot of the VCI;
a second probabilistic data structure engine configured to create a second probabilistic data structure representing the second tree data structure, wherein the second probabilistic data structure includes hashes of the identifiers assigned to the nodes of the second tree data structure; and
a determination engine configured to determine that a particular node of the second tree data structure is shared by the first tree data structure responsive to a determination that the first probabilistic data structure and the second probabilistic data structure each include a hash of an identifier assigned to the particular node.

16. The system of claim 15, wherein the determination engine is configured to determine that another particular node of the second tree data structure is not shared by the first tree data structure responsive to a determination that the first probabilistic data structure does not include a hash of an identifier assigned to the other particular node.

17. The system of claim 16, wherein the determination engine is configured to delete extents of the other particular node responsive to the determination that the other particular node is not shared.

18. The system of claim 15, including:
a third identifier engine configured to assign a unique identifier to each node of a third tree data structure corresponding to a third snapshot of the VCI;
a third probabilistic data structure engine configured to create a third probabilistic data structure representing the third tree data structure, wherein the third probabilistic data structure includes hashes of the identifiers assigned to the nodes of the third tree data structure;
a request engine configured to receive a request to delete the second snapshot;
the determination engine configured to:
determine that a particular node of the second tree data structure is shared by either the first tree data structure or the third tree data structure responsive to a determination that the first probabilistic data structure or the third probabilistic data structure includes a hash of an identifier assigned to the particular node; and
not delete the particular node responsive to the determination that the particular node is shared.

19. The system of claim 15, including:
a third identifier engine configured to assign a unique identifier to each node of a third tree data structure corresponding to a third snapshot of the VCI, wherein the third snapshot is writeable;
a third probabilistic data structure engine configured to create a third probabilistic data structure representing the third tree data structure, wherein the third probabilistic data structure includes hashes of the identifiers assigned to the nodes of the third tree data structure;
a request engine configured to receive a request to delete the second snapshot;
the determination engine configured to:
determine that a particular node of the second tree data structure is not shared by either the first tree data structure or the third tree data structure responsive to a determination that neither the first probabilistic data structure nor the third probabilistic data structure includes a hash of an identifier assigned to the particular node; and
delete the particular node responsive to the determination that the particular node is not shared.

20. The system of claim 15, wherein:
the first identifier engine is configured to assign a new unique identifier to a new node of the first tree data structure, wherein the first tree data structure is one of: a B−tree, a B+tree, a binary tree, an AVL tree, and a trie; and
the first probabilistic data structure engine is configured to add a hash of the new identifier to the first probabilistic data structure.
